(19) United States
(12) Patent Application Publication
(10) Pub. No.: US 2017/0243500 A1
(43) Pub. Date: Aug. 24, 2017

(54) Method and a System for Automatic Assessment of a Candidate

(71) Applicant: Wipro Limited, Bangalore (IN)

(72) Inventors: Anasuya Devi KOMPELLA, Bangalore (IN); Sawani BADE, Bangalore (IN); Nirmala SEETHAPPAN, Erode (IN)

(21) Appl. No.: 15/065,078

(22) Filed: Mar. 9, 2016

(30) Foreign Application Priority Data
Feb. 24, 2016 (IN) 201641006397

(51) Int. Cl. G09B 7/02

(52) U.S. Cl. CPC G09B 7/02

(57) ABSTRACT

The present disclosure relates to a method and system for automatic assessment of a candidate. The method comprises receiving one or more answers from the candidate to one or more questions provided to the candidate, wherein the one or more questions provided to the candidate are related to one or more domains of expertise of the candidate. One or more keywords and key phrases are extracted from the received answers. Also, relationship among the one or more keywords and key phrases are identified upon extracting the key words and key phrases from the answers. Further, a multi-level score is assigned to each of the one or more answers based on the one or more keywords, key phrases and the relationship among the keywords and key phrases. The candidate is assessed based on the multi-level score assigned to each of the one or more answers received from the candidate.

### TECHNICAL FIELD

The present subject matter is related, in general to assessment system, and more particularly, but not exclusively to a method and a system for automatic assessment of a candidate.

### BACKGROUND

Recruitment is one of a major time consuming process in any organization. Finding the right talent on an ongoing basis is a major pre-requisite for retaining competitive advantage. Often, organizations have a significant amount of workforce dedicated for mining the job sites, finding the right profiles, screening them through interviewing panels, short-listing them and selecting them.

Most of the interview processes revolve around a free-flow conversation about various technical topics relevant to job requirements. The questions are meant to assess the basic understanding of concepts as well as depth of knowledge possessed by the candidate. However, manually assessing the answers given by a candidate is subjective to the knowledge and judgment of interviewers. The consistency and the quality of the manual assessment are not guaranteed. Hence, the manual assessment may result in bad-hires leading to unsatisfactory results from recruitment process. Further, finding a right interviewing panelist with required skills and experience as well as in identifying the availability of the interviewing panelists matching with the candidate's availability would be a tough challenge.

There may be different challenges for automated assessment of answers. The answers given by the candidate may be a few words to a paragraph long. Also, there is no fixed way of answering the questions. Hence, the candidates can provide answers based on their own interpretation/understanding of concepts and the questions provided to them.

Also human assessment can vary from being very conservative to moderate to very liberal. So, there is a possibility that the learning algorithm would be biased accordingly. In conventional methods, massive training data and/or manually collated synonyms etc are provided. However it is not always feasible to provide the required volume of training data and it is also very cumbersome exercise to manually curate domain specific synonyms.

### SUMMARY

Disclosed herein is a method and system for automatic assessment of a candidate. The automatic assessment of a candidate involves assessing the candidate for specific skills in a domain without any human intervention. A virtual interviewing system described in the present disclosure comprises different modules for assessing the candidate based on the type of questions and respective answers given by the candidate.

Accordingly, the present disclosure relates to a method for automatic assessment of a candidate. The method comprises receiving, by a virtual interviewing system, one or more answers from the candidate to one or more questions provided to the candidate, wherein the one or more questions provided to the candidate are related to one or more domains of expertise of the candidate. One or more keywords and key phrases are extracted from the one or more received answers. Further, relationship among the one or more keywords and key phrases are identified upon extracting the one or more key words and key phrases from the answers. Further, a multi-level score is assigned to each of the one or more answers by validating each of the one or more keywords and key phrases and the relationship among the one or more keywords and key phrases. The candidate is assessed based on the multi-level score assigned to each of the one or more answers.

Further, the present disclosure relates to a virtual interviewing system for automatic assessment of a candidate. The system comprises a processor and memory communicatively coupled to the processor, wherein the memory stores processor-executable instructions, which, on execution, causes the processor to receive one or more answers from the candidate to one or more questions provided to the candidate, wherein the one or more questions provided to the candidate are related to one or more domains of expertise of the candidate. The instructions cause the processor to extract one or more keywords and key phrases from the one or more answers. The instructions further cause the processor to identify relationship among the one or more keywords and key phrases. The processor of the virtual interviewing system assigns a multi-level score to each of the one or more answers by validating each of the one or more keywords and key phrases and the relationship among the one or more keywords and key phrases. Furthermore, the instruction causes the processor to assess the candidate based on the multi-level score assigned to each of the one or more answers.

Furthermore, the present disclosure relates to a non-transitory computer readable medium including instructions stored thereon that when processed by at least one processor cause a virtual interviewing system to perform operations comprising receiving one or more answers from the candidate to one or more questions provided to the candidate, wherein the one or more questions provided to the candidate are related to one or more domains of expertise of the candidate. The instructions cause the processor to extract one or more keywords and key phrases from the one or more answers identifying order of occurrence of the one or more keywords and key phrases and relationship among the one or more keywords and key phrases. The instructions further cause the processor to assign a multi-level score to each of the one or more answers by validating each of the one or more keywords and key phrases and the relationship among the one or more keywords and key phrases. Further, the instruction causes the processor to assess the candidate based on the multi-level score assigned to each of the one or more answers.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment for automatic assessment of a candidate in accordance with some embodiments of the present disclosure;

FIG. 2a shows a detailed block diagram of a virtual interviewing system in accordance with some embodiments of the present disclosure;

FIG. 2b illustrates a method of generating one or more training models in the virtual interviewing system in accordance with some embodiments of the present disclosure;

FIG. 3 illustrates a flowchart showing a method for automatic assessment of a candidate in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and system for automatic assessment of a candidate. The method comprises receiving, by a virtual interviewing system, one or more answers from the candidate to one or more questions provided to the candidate, wherein the one or more questions provided to the candidate are related to one or more domains of expertise of the candidate. One or more keywords and key phrases are extracted from the one or more received answers. Further, relationship among the one or more keywords and key phrases are identified upon extracting the one or more key words and key phrases from the answers. Further, a multi-level score is assigned to each of the one or more answers by validating each of the one or more keywords and key phrases and the relationship among the one or more keywords and key phrases. The candidate is assessed based on the multi-level score assigned to each of the one or more answers.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

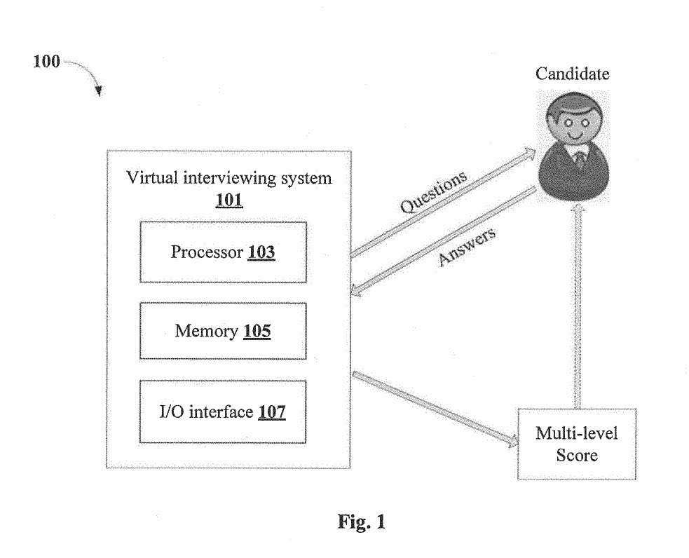

FIG. 1 shows an exemplary environment for automatic assessment of a candidate in accordance with some embodiments of the present disclosure.

The environment 100 shows a virtual interviewing system 101 for assessing a candidate. The virtual interviewing system 101 comprises a processor 103, a memory 105 and an I/O interface 107. In an embodiment, the virtual interviewing system 101 may receive one or more information related to the candidate before assessing the candidate. The one or more information received from the candidate may include, but not limited to, name of the candidate, occupation and/or education of the candidate, domain of expertise of the candidate etc. Upon receiving the one or more information related to the candidate, the virtual interviewing system 101 may provide one or more questions 205 to the candidate, through the I/O interface 107, to assess the knowledge and/or skills of the candidate. The one or more questions 205 provided to the candidate are the one or more questions 205 related to a domain of expertise of the candidate. In an embodiment, the candidate may provide one or more answers 207 to the one or more questions 205 provided by the virtual interviewing system 101. Upon receiving the one or more answers 207, the processor 103 assigns a multi-level score 211 to each of the one or more answers 207. The candidate may be assessed based on the multi-level score 211 assigned to the one or more answers 207. The method of scoring the one or more answers 207 is briefly explained in the below sections.

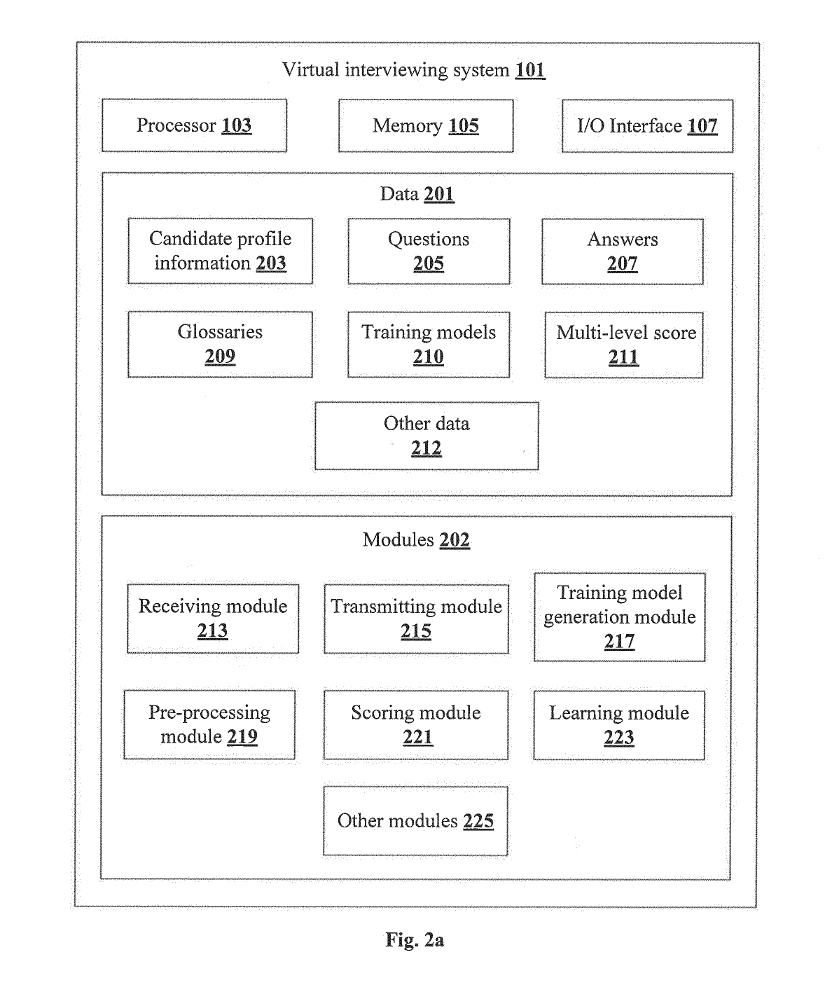

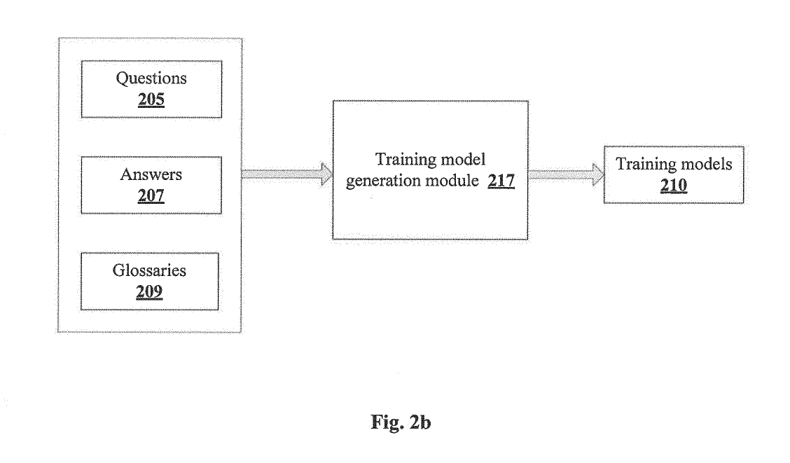

FIG. 2a shows a detailed block diagram of a virtual interviewing system in accordance with some embodiments of the present disclosure.

In an embodiment, the virtual interviewing system 101 further comprises data 201 and modules 202 for performing various operations in accordance with the embodiments of the present disclosure. In one implementation, the data 201 may be stored within the memory 105. In an embodiment, the data 201 includes, without limitation, candidate profile information 203, questions 205, answers 207, glossaries 209, training models 210, multi-level scores 211 assigned to each of the one or more answers 207 and other data 212. The other data 212 may store data, including temporary data and temporary files, generated by modules 202 for performing the various functions of the virtual interviewing system 101.

In an embodiment, the candidate profile information 203 comprises the one or more details related to the candidate. As an example, the candidate profile information 203 of the candidate may include, but not limited to, name of the candidate, occupation and/or education of the candidate, domain of expertise of the candidate etc. In an embodiment, the virtual interviewing system 101 uses the candidate profile information 203 to provide one or more most suitable/relevant questions 205 to the candidate.

In an embodiment, the one or more questions 205 stored in the virtual interviewing system 101 are the questions 205 used to test the domain knowledge and/or skills of the candidate. The one or more questions 205 may be collected from one or more online and/or offline sources including, without limitation, one or more questions 205 used in the earlier assessment programs, technical question banks, online assessment portals and from one or more technical textbooks/reference and discussion forums. The one or more questions 205 stored in the virtual interviewing system 101 may be classified into one or more categories/types of questions 205. As an example, the one or more categories of questions 205 include Multiple Choice Questions (MCQs), factoids and open ended questions. MCQs are a form of assessment in which candidates are asked to select the best possible answer/answers 207 out of the choices from a list. Factoids are the questions 205 whose answers 207 are generally of single word length or a phrase containing 2-3 words. Open ended questions are the questions 205 whose answers 207 are of varying lengths, such as, sentences and paragraphs. The open-ended questions often include questions 205 on concept definitions, differentiating between multiple concepts and ordering of concepts.

In an embodiment, the answers 207 stored in the virtual interviewing system 101 may be the one or more answers 207 received from the candidate. In an embodiment, the answers 207 stored in the virtual interviewing system 101 may be the one or more answers 207 corresponding to one or more questions 205, which are pre-stored by one or more human experts. The human experts are persons having depth of knowledge in one or more domains of expertise. In an embodiment, the one or more answers 207 received from the candidates may be compared with the one or more pre-stored answers 207 for verifying the correctness of the one or more answers 207 received from the candidate. Further, the one or more answers 207 received from the candidate may be processed in order to assess the candidate. In an embodiment, a minimum of, say, 10 different answers 207 may be stored in the virtual interviewing system 101 in order to improve the accuracy of the assessment. The multiple answers 207 corresponding to each of the one or more answers 207 may be reviewed by the one or more experts to ensure that they are relevant to the questions 205 and are different from each other in terms of vocabulary, structure and completeness.

In an embodiment, glossaries 209 may comprise one or more words and technical references corresponding to one or more key words and key phrases in the one or more answers 207 related to a domain of the expertise of the candidate. The one or more words and technical references in the glossary 208 may be collected from one or more online and/or offline sources including, without limitation, one or more technical guides/textbooks, tutorials and the similar. The glossary 208 may be used to extract one or more keywords and key phrases from the one or more answers 207 and to identify relationship among the one or more keywords and the key phrases.

In an embodiment, the one or more training models 210 may comprise at least one of one or more questions 205 related to one or more domains of expertise, a plurality of answers 207 to each of the one or more questions 205 and scores provided to each of the plurality of answers 207. FIG. 2b shows the method of generating one or more training models 210 using a training model generation module 217 in the virtual interviewing system 101. In an embodiment, the training model generation module 217 may take the one or more words and technical references in the glossaries 209 as input for generating the one or more training models 210. The training model generation module 217 may also consider the one or more questions 205 and one or more answers 207 to each of the one or more questions 205 for generating the one or more training models 210. Each of the one or more training models 210 may be explicitly relating to one of the domains of expertise.

In an embodiment, the multi-level score 211 are the scores assigned to each of the one or more answers 207. For instance, each of the one or more answers 207 may be scored by the one or more human experts. In order to ensure genuineness of the scores provided by the individual human experts, same answers 207 are scored by multiple human experts. Finally, two of the most consistent scorers are selected as the final score of the answer. Consistency in the scores may be determined by how close are the scores, assigned by each of the one or more experts, to a mean score of the answer.

In an implementation, the data 201 stored in the memory 105 are processed by the modules 202 of the virtual interviewing system 101. In an embodiment, the modules 202 may be stored within the memory 105. In an alternative embodiment, the modules 202 may also be present outside the memory 105 and may be communicatively coupled to the processor 103.

In an embodiment, the modules 202 may include, without limitation, a receiving module 213, a transmitting module 215, a training model generation module 217, a pre-processing module 219, the scoring module 221, a learning module 223 and other modules 225. The other modules 225 may be used to perform various miscellaneous functionalities of the virtual interviewing system 101. It will be appreciated that such aforementioned modules 202 may be represented as a single module or a combination of different modules.

In an embodiment, the receiving module 213 is configured to receive one or more answers 207 from the candidate for the one or more questions 205 provided to the candidate. The receiving module 213 may also receive the candidate profile information 203 related to the candidate. The one or more data 201 received by the receiving module 213 may be used by one or more modules 202 to evaluate and assess the candidate. In another embodiment, the receiving module 213 may receive one or more questions 205 from one or more sources, which may be provided to the candidates while automatic assessment of the candidates. One or more questions 205, relating to one or more domains of expertise may be collected from one or more pre-existing enterprise question banks, such as, the questions 205 used in previous interviews/training/internal assessment programs. As an example, the pre-existing enterprise question banks may be collected from online resources and technical community forums.

In an embodiment, the transmitting module 215 transmits and/or provides one or more questions 205 to the candidates for assessing the candidate. The transmitting module 215 may use the I/O interface 107 to display/read out the one or more questions 205 to the candidate. In an embodiment, the transmitting module 215 is responsible for providing the assessment report to the candidate. The assessment report may include, without limiting to, final score assigned to each of the one or more answers 207 given by the candidate.

In an embodiment, the training model generation module 217 generates one or more training models 210 corresponding to the one or more domains of expertise. Each of the one or more training models 210 defines the relevance of the one or more answers 207 to their corresponding domain of expertise. The process of generating the one or more training models 210 is illustrated in FIG. 2b.

In an embodiment, the pre-processing module 219 performs preprocessing of the one or more answers 207 received from the candidate before generating the one or more training models 210. The preprocessing of the one or more answers 207 may include eliminating special characters from the one or more answers 207. The pre-processing module 219 may also extract nouns, verb phrases and key relationship among the verb phrases from the one or more answers 207. The extracted nouns and key phrases may be stored as a feature vector, which may be used to derive the key relationships between one or more domain specific and/or technical words in the one or more answers 207. In an embodiment, a feature vector may be constructed for each of the one or more answers 207. The feature vector consists of binary values (0's or 1's) for representing different feature functions. For example, a feature vector, ƒ(x), for determining presence of a word “x” in the received answer 207 may be of the form:

$$f ( x ) = \{ \begin{matrix}0 , if word x is not present in the answer \\ 1 , if word x is present in the answer\end{matrix}$$

Further, the pre-processing module 219 may eliminate one or more natural language stop words in the one or more answers 207. The natural language stop words are the most common words used in a language. The domain specific and/or technical stop words in the one or more answers 207 may be retained by the pre-processing module 219 and may be used as an additional parameter for scoring the one or more answers 207.

In an embodiment, certain natural language stop words may happen to be the domain specific stop words. Such natural language stop words are retained in the one or more answers 207. For e.g. natural language stop words like “for”, “if”, and “else” are significant in a technical programming domain. Hence, these are not removed while eliminating the other natural language stop words. In an embodiment, the pre-processing module 219 may use a standard stemming algorithm like porter stemmer for eliminating various forms and/or synonyms of a single word.

In an embodiment, the one or more answers 207 received by the candidate are analyzed to identify one or more irrelevant answers 207 among the one or more answers 207 given by the candidate. The irrelevant answers are the one or more answers 207 which have no relation to the question being asked. The one or more irrelevant answers 207 may be identified by comparing the one or more keywords and key phrases in each of the one or more answers 207 with the one or more keywords and key phrases in the one or more answers 207 in the one or more training models 210. In an exemplary embodiment, one or more answers 207 comprising the phrases ‘I don't know’ or ‘I have not worked in this area’ are captured separately in order to suitably modify the line of interview. Accordingly the virtual interviewing system 101 changes the flow of one or more questions 205 provided to the candidate.

In an embodiment, the scoring module 221 assigns a multi-level score 211 to the one or more answers 207 received from the candidate using the one or more training models 210 generated by the training model generation module 217. An initial level of the multi-level score 211 may be assigned to each of the one or more answers 207 by validating the one or more keywords and key phrases in the one or more answers 207. In an embodiment, the method of validating the one or more key words and key phrases comprises comparing each of the one or more keywords and key phrases with the one or more keywords and key phrases stored in the training model 210 to check if there is a match between the keywords and the key phrases.

In an embodiment, the scoring module 221 assigns a final level of the multi-level score 211 to the one or more answers 207 by validating the relationship among the one or more keywords and key phrases in the one or more answers 207. The method of validating the relationship among the one or more keywords and key phrases comprises comparing the relationship among the one or more keywords and key phrases with the relationship among the one or more keywords and key phrases stored in the training model 210. The final level score of the multi-level score 211 may be assigned to the one or more answers 207 only when the assigned initial level of the multi-level score 211 is higher than a predetermined value.

As an example, one of the questions 205 provided by the virtual interviewing system 101 for assessing the candidate may be is to define the term “array”. The candidate may, in turn provide an answer 207, such as, “array is a static data structure that stores data elements of single data type”. The virtual interviewing system 101 extracts one or more keywords and key phrases from the answer 207 upon receiving the answer 207 from the candidate. The one or more keywords and key phrases extracted from the received answer 207 may be “static”, “data structure” and “single data type”. Upon extracting the one or more keywords and key phrases from the answer 207, the scoring module 221 of the virtual interviewing system 101 assigns a multi-level score 211 to the answer 207. An initial level of the multi-level score 211 may be assigned by comparing each of the one or more extracted keywords and key phrases with the one or more keywords and key phrases stored in one of the one or more training models 210 stored in the virtual interviewing system 101. In an exemplary embodiment, the comparison may result in a good match when the one or more keywords and key phrases in the received answer 207 matches with a predefined percentage, say 80% of the one or more keywords and key phrases in the one or more answers 207 stored in the one or more training models 210.

Upon assigning the initial level of the multi-level score 211, the scoring module 221 may further assign the final level of the multi-level score 211 to the received answer 207 when the assigned initial level score is more than a predetermined value. The final level of the multi-level score 211 may be assigned by comparing the relationship among the one or more keywords and key phrases with the relationship among the one or more keywords and key phrases stored in the one or more training models 210. As an example, the predetermined value of initial level in the multi-level score 211 may be 4 or higher, assuming the range of scores is 0 to 5. In an embodiment, the predetermined value of the initial level score may be varied as per requirements of the one or more human experts and/or recruitment personal associated with the virtual interviewing system 101. Hence, in the example briefed above, the scoring module 221 assigns a final level of the multi-level score 211 since the assigned initial level score (initial level score=4) is higher or equal to the predetermined value, i.e. 4. Further, the final level of the multi-level score 211 assigned by the scoring module 221 may be considered as the final score for the answer 207 received from the candidate.

In an embodiment, the scoring module 221 may also check for completeness of the one or more answers 207 given by the candidate. The completeness of the one or more answers 207 may be checked by comparing the one or more keywords and key phrases in the one or more answers 207 against the one or more answers 207 top-scored by the one or more human experts. Determining the completeness of the one or more answers 207 may help in prompting the candidate with follow-up questions 205 on the missing aspects of the one or more answers 207. In another embodiment, one or more grammatical errors found in the one or more candidate answers 207 may be captured by the virtual interviewing system 101. The captured grammatical errors may be provided as a feedback on the natural language skills of the candidate.

In an embodiment, the learning module 223 may be used to implement one or more assessment improvement techniques for the virtual interviewing system 101. Each of the one or more evaluations and/or scores assigned to the one or more candidates are reviewed by the one or more human experts for verifying the accuracy of the virtual interviewing system 101. The one or more human experts may retain the final level score generated by the scoring module 221 as the final score for the candidate. Alternatively, the one or more experts may modify the final level score assigned by the scoring model when it is found to be inappropriate.

In an embodiment, the learning module 223 updates the one or more training models 210 based on the modifications to the final level score of the candidate. Updating the one or more training models 210 for including the modification may help in improving the accuracy of the one or more training models 210 over a period of time. Further, if multiple answers 207 received from the candidate are found to be inaccurately scored, the learning module 223 may provide one or more notifications to the one or more human experts. The one or more notifications generated by the learning module 223 may hint on the possibility of insufficient training models 210 for the one or more questions 205 under consideration. The one or more human experts are then required to act upon the notification by reviewing the one or more training models 210.

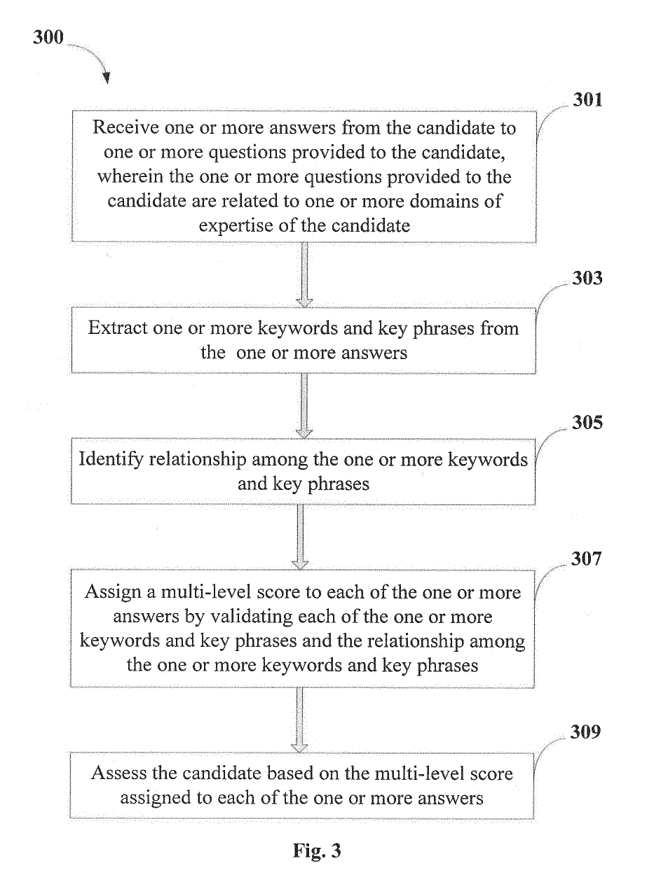

FIG. 3 illustrates a flowchart showing a method for automatic assessment of a candidate in accordance with some embodiments of the present disclosure.

As illustrated in FIG. 3, the method 300 comprises one or more blocks for automatic assessment of the candidate using the virtual interviewing system 101. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein.

Furthermore, the method can be implemented in any suitable hardware, software, firmware, or combination thereof.

At block 301, the virtual interviewing system 101 receives one or more answers 207 from the candidate to one or more questions 205 provided to the candidate, wherein the one or more questions 205 provided to the candidate are related to one or more domains of expertise of the candidate. The one or more questions 205 to be provided to the candidate may be stored in the memory 105 of the virtual interviewing system 101.

At block 303, the virtual interviewing system 101 extracts one or more keywords and key phrases from the one or more answers 207. In an embodiment, the one or more keywords and key phrases are extracted by eliminating one or more natural language stop words from the received answers 207.

At block 305, the virtual interviewing system 101 identifies a relationship among the one or more keywords and key phrases using the one or more training models 210 in the virtual interviewing system 101. Each of the one or more training models 210 comprises at least one of one or more questions 205 related to one or more domains of expertise, a plurality of answers 207 to each of the one or more questions 205 and scores provided to each of the plurality of answers 207. In an embodiment, configuring the one or more training models 210 further comprises pre-processing each of the plurality of answers 207 to eliminate at least one of one or more special characters and natural language stop words in each of the plurality of answers 207. The one or more keywords and key phrases, and relationship among the one or more keywords and key phrases are identified in each of the plurality of answers 207 upon pre-processing the plurality of answers 207. Further, one or more human experts having expertise in the one or more domains of expertise provide a score to each of the plurality of answers 207 upon identifying the keywords, key phrases and the relationship among the keywords and the key phrases.

At block 307, the virtual interviewing system 101 assigns a multi-level score 211 to each of the one or more answers 207 by validating each of the one or more keywords and key phrases and the relationship among the one or more keywords and key phrases. The scoring module 221 in the virtual interviewing system 101 assigns an initial level of the multi-level score 211 to each of the one or more answers 207 by validating the one or more keywords and key phrases in the one or more answers 207. In an embodiment, the method of validating the one or more key words and key phrases comprises comparing each of the one or more keywords and key phrases with the one or more keywords and key phrases stored in the training model 210 to check if there is a match between the keywords and the key phrases. Further, the scoring module 221 assigns a final level of the multi-level score 211 to the one or more answers 207 by validating the relationship among the one or more keywords and key phrases in the one or more answers 207. The method of validating the relationship among the one or more keywords and key phrases comprises comparing the relationship among the one or more keywords and key phrases with the relationship among the one or more keywords and key phrases stored in the training model 210. The final level score of the multi-level score 211 may be assigned to the one or more answers 207 only when the assigned initial level of the multi-level score 211 is higher than a predetermined value.

At block 309, the virtual interviewing system 101 assesses the candidate based on the multi-level score 211 assigned to each of the one or more answers 207. The final level of the multi-level score 211 assigned to the answer 207 received from the candidate may be considered as the final score of the candidate.

Further, the virtual interviewing system 101 performs one or more learning assessment improvement techniques by evaluating each of the one or more answers 207 and the corresponding multi-level score 211 assigned to each of the one or more answers 207 by the one or more human experts for checking accuracy of the assessment. Also, the virtual interviewing system 101 provides a notification upon detecting an inaccurate scoring of the one or more answers 207. Further, one or more evaluation reports are generated for improving performance and management of the virtual interviewing system 101 based on the accuracy of the assigned multilevel score.

### Computer System

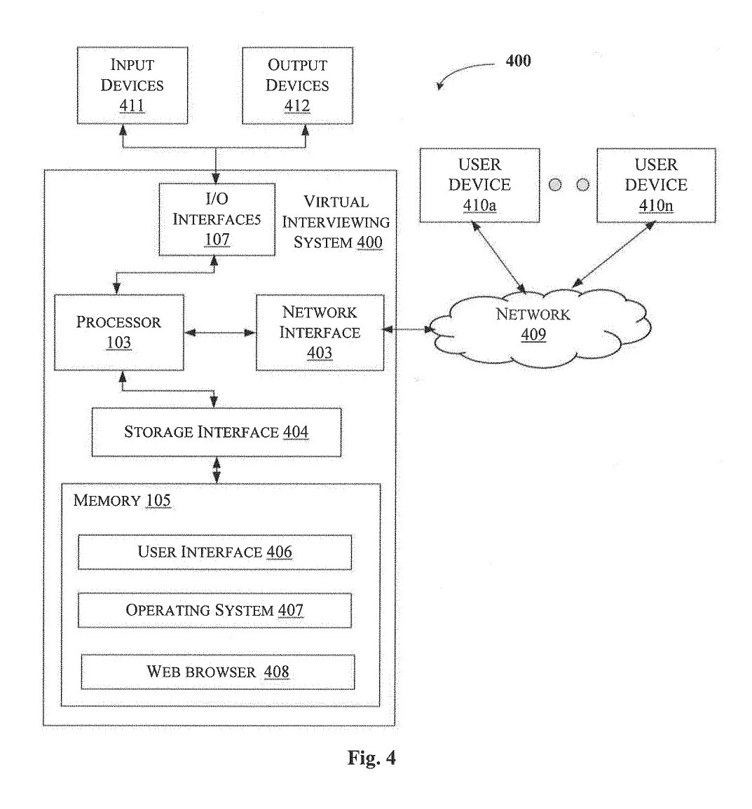

FIG. 4 illustrates a block diagram of an exemplary computer system 400 for implementing embodiments consistent with the present invention. In an embodiment, the computer system 400 is used for automatic assessment of a candidate using a virtual interviewing system 101. The computer system 400 may comprise a central processing unit (“CPU” or “processor”) 103. The processor 103 may comprise at least one data processor for executing program components for executing user- or system-generated business processes. A user may include a person, a person using a device such as such as those included in this invention, or such a device itself. The processor 103 may include specialized processing units such as integrated system (bus) controllers, memory management control units, floating point units, graphics processing units, digital signal processing units, etc.

The processor 103 may be disposed in communication with one or more input/output (I/O) devices (411 and 412) via I/O interface 107. The I/O interface 107 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc. Using the I/O interface 107, the computer system 400 may communicate with one or more I/O devices (411 and 412).

In some embodiments, the processor 103 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with one or more user devices 108 (1, . . . , n). The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. The one or more user devices 108 (1, . . . , n) may include, without limitation, personal computer(s), mobile devices such as cellular telephones, smartphones, tablet computers, eBook readers, laptop computers, notebooks, gaming consoles, or the like.

In some embodiments, the processor 103 may be disposed in communication with a memory 105 (e.g., RAM, ROM, etc. not shown in FIG. 4) via a storage interface 404. The storage interface 404 may connect to memory 105 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 105 may store a collection of program or database components, including, without limitation, user interface application 406, an operating system 407, web server 408 etc. In some embodiments, computer system 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. User interface 406 may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein

In an embodiment, the present disclosure provides a method and a system for automatic assessment of a candidate during a recruitment process.

In an embodiment, the present disclosure eliminates the need for manual intervention for assessing and selecting the candidates, thereby, increasing objectivity of the assessment and reducing time required for assessing the candidate resulting in an increased number of candidates being assessed.

In an embodiment, the present disclosure provides an accurate and reliable method of assessing the candidates by eliminating the occurrence of manual errors during any interview.

In an embodiment, the method of present disclosure provides a multi-level score to the candidate, thereby helping the candidates self-evaluate their skills and/or depth of knowledge in a given domain of expertise.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### Referral Numerals:

| Reference | |
|---|---|
| Number | Description |
| 100 | Environment |
| 101 | Virtual interviewing system |
| 103 | Processor |
| 105 | Memory |
| 107 | I/O interface |
| 201 | Data |
| 202 | Modules |
| 203 | Candidate profile information |
| 205 | Questions |
| 207 | Answers |
| 209 | Glossaries |
| 210 | Training models |
| 211 | Multi-level score |
| 212 | Other data |
| 213 | Receiving module |
| 215 | Transmitting module |
| 217 | Training model generation module |
| 219 | Pre-processing module |
| 221 | Scoring module |
| 223 | Learning module |
| 225 | Other modules |

We claim:

1. A method for automatic assessment of a candidate, the method comprising:
receiving, by a virtual interviewing system, one or more answers from the candidate to one or more questions provided to the candidate, wherein the one or more questions provided to the candidate are related to one or more domains of expertise of the candidate;
extracting, by the virtual interviewing system, one or more keywords and key phrases from the one or more answers;
identifying, by the virtual interviewing system, relationship among the one or more keywords and key phrases;
assigning, by the virtual interviewing system, a multi-level score to each of the one or more answers by validating each of the one or more keywords and key phrases and the relationship among the one or more keywords and key phrases; and
assessing, by the virtual interviewing system, the candidate based on the multi-level score assigned to each of the one or more answers.

2. The method as claimed in claim 1 further comprises configuring the virtual interviewing system with one or more training models before assessing the candidate.

3. The method as claimed in claim 2, wherein each of the one or more training models comprises at least one of one or more questions related to one or more domains of expertise, a plurality of answers to each of the one or more questions and scores provided to each of the plurality of answers.

4. The method as claimed in claim 2, wherein configuring the one or more training models further comprises:
pre-processing each of the plurality of answers to eliminate at least one of one or more special characters and natural language stop words in each of the plurality of answers;
identifying the one or more keywords and key phrases, and relationship among the one or more keywords and key phrases in each of the plurality of answers; and
providing a score to each of the plurality of answers by one or more human experts having expertise in the one or more domains of expertise.

5. The method as claimed in claim 1, wherein validating each of the one or more keywords and key phrases and the relationship among the one or more keywords and key phrases further comprises comparing each of the one or more keywords and key phrases and the relationship among the one or more keywords and key phrases with the one or more keywords and key phrases and the relationship among the one or more keywords and key phrases stored in the training model.

6. The method as claimed in claim 1, wherein assigning the multi-level score to each of the one or more answers comprises:
assigning an initial level score to each of the one or more answers upon validating the one or more keywords and key phrases in the one or more answers; and
assigning a final level score to the one or more answers by validating the relationship among the one or more keywords and key phrases when the assigned initial level score is higher than a predetermined value.

7. The method as claimed in claim 1 further comprises performing one or more learning assessment improvement techniques by:
evaluating each of the one or more answers and the corresponding multi-level score assigned to each of the one or more answers by the one or more human experts for checking accuracy of the assessment; and
providing a notification upon detecting an inaccurate scoring of the one or more answers.

8. The method as claimed in claim 7 further comprises generating one or more evaluation reports for improving performance and management of the virtual interviewing system based on the accuracy of the assigned multilevel score.

9. A virtual interviewing system for automatic assessment of a candidate, the system comprising:
a processor, and
a memory communicatively coupled to the processor, wherein the memory stores processor-executable instructions, which, on execution, causes the processor to:
receive one or more answers from the candidate to one or more questions provided to the candidate, wherein the one or more questions provided to the candidate are related to one or more domains of expertise of the candidate;
extract one or more keywords and key phrases from the one or more answers;
identify relationship among the one or more keywords and key phrases;
assign a multi-level score to each of the one or more answers by validating each of the one or more keywords and key phrases and the relationship among the one or more keywords and key phrases; and
assess the candidate based on the multi-level score assigned to each of the one or more answers.

10. The system as claimed in claim 9 is further configured with one or more training models before assessing the candidate.

11. The system as claimed in claim 10, wherein each of the one or more training models comprises at least one of one or more questions related to one or more domains of expertise, a plurality of answers to each of the one or more questions and scores provided to each of the plurality of answers.

12. The system as claimed in claim 10, wherein the processor configures the one or more training models by:
pre-processing each of the plurality of answers to eliminate at least one of one or more special characters and natural language stop words in each of the plurality of answers;
identifying the one or more keywords and key phrases, and relationship among the one or more keywords and key phrases in each of the plurality of answers; and
providing a score to each of the plurality of answers by one or more human experts having expertise in the one or more domains of expertise.

13. The system as claimed in claim 9, wherein the instructions further causes the processor to validate each of the one or more keywords and key phrases and the relationship among the one or more keywords and key phrases further comprises comparing each of the one or more keywords and key phrases and the relationship among the one or more keywords and key phrases with the one or more keywords and key phrases and the relationship among the one or more keywords and key phrases stored in the training model.

14. The system as claimed in claim 9, wherein the instructions causes the processor to assign the multi-level score to each of the one or more answers by:
assigning an initial level score to each of the one or more answers upon validating the one or more keywords and key phrases in the one or more answers; and
assigning a final level score to the one or more answers by validating the order of occurrence of the one or more keywords and key phrases and the relationship among the one or more keywords and key phrases when the assigned initial level score is higher than a predetermined value.

15. The system as claimed in claim 9, wherein the instructions further causes the processor to perform one or more learning assessment improvement techniques by:
evaluating each of the one or more answers and the corresponding multi-level score assigned to each of the one or more answers by the one or more human experts for checking accuracy of the assessment; and
providing a notification upon detecting an inaccurate scoring of the one or more answers.

16. The system as claimed in claim 15, wherein the instructions further causes the processor to generate one or more evaluation reports for improving performance and management of the virtual interviewing system based on the accuracy of the assigned multilevel score.

17. A non-transitory computer readable medium including instructions stored thereon that when processed by at least one processor cause a virtual interviewing system to perform operations comprising:
receiving one or more answers from the candidate to one or more questions provided to the candidate, wherein the one or more questions provided to the candidate are related to one or more domains of expertise of the candidate;
extracting one or more keywords and key phrases from the one or more answers;
identifying order of occurrence of the one or more keywords and key phrases and relationship among the one or more keywords and key phrases;
assigning a multi-level score to each of the one or more answers by validating each of the one or more keywords and key phrases and the relationship among the one or more keywords and key phrases; and
assessing the candidate based on the multi-level score assigned to each of the one or more answers.
